(19) United States
(12) Patent Application Publication
(10) Pub. No.: US 2026/0156224 A1
(43) Pub. Date: Jun. 4, 2026

(54) IMAGE READING APPARATUS

(71) Applicant: CANON DENSHI KABUSHIKI KAISHA, Saitama (JP)

(72) Inventor: Koji MIYANISHI, Saitama (JP)

(21) Appl. No.: 19/407,379

(22) Filed: Dec. 3, 2025

(30) Foreign Application Priority Data
Dec. 4, 2024 (JP) 2024-210994
Oct. 24, 2025 (JP) 2025-179855

(51) Int. Cl. H04N 1/21; H04N 1/00; H04N 1/32; H04N 1/44

(52) U.S. Cl. CPC H04N 1/21; H04N 1/00824; H04N 1/00973; H04N 1/32101; H04N 1/4426; H04N 1/4433; H04N 2201/0081; H04N 2201/3269

(57) ABSTRACT

An object of the present disclosure is to shorten the time required for a user before starting a scan of a document after placing it. An embodiment of the present disclosure includes: an operation unit configured such that a user performs an operation thereon; an image reading unit configured to perform an image reading process of reading a document; a storage unit configured to temporarily save an image data obtained by the image reading unit; and a control unit configured to perform control on the read image temporarily saved in the storage unit. After start of the image reading process, access information for accessing the control unit is displayed on the operation unit.

### BACKGROUND

### Field of the Technology

The present disclosure relates to an image reading apparatus.

### Description of the Related Art

As an image reading apparatus for reading a document and generating image data of the document has been known which is equipped with a web server to be accessible by web browsers on external apparatuses. The image reading apparatus equipped with a web server can receive a scan instruction through an operation screen provided to a web browser without requiring a dedicated application or driver. In response to receiving a scan instruction, the web server performs a scanning process.

Image data obtained by the scanning process is temporarily saved to a volatile memory inside the image reading apparatus in order to prevent the image data to be obtained by third parties on the same network. In response to receiving a transmission instruction, the web server transmits the image data saved in the above volatile memory to the external apparatus.

In Japanese Patent Laid-Open No. 2001-358880, a means is provided which allows a user to open a web browser on an external apparatus, perform a scan through an operation screen provided to the web browser, and obtain an image file.

Here, the following procedure is needed to access the image reading apparatus from a web browser on an external apparatus. First, the Internet Protocol (IP) address of the image reading apparatus is checked. Then, the web browser on the external apparatus is launched, and the IP address of the image reading apparatus confirmed in advance is input into the uniform resource locator (URL) field of the web browser. Also, to start a scan, it is necessary to further configure scan settings on the operation screen provided by the web server and press a scan button. In sum, a certain length of time is required before the user starts the actual image reading.

### SUMMARY

The present disclosure is directed to providing a technique for shortening the time required for a user before scanning a document and obtaining an image.

In view of the above, an image reading system according to an embodiment of the present disclosure includes: an operation unit configured such that a user performs an operation thereon; an image reading unit configured to perform an image reading process of reading a document; a storage unit configured to temporarily save an image data obtained by the image reading unit; and a control unit configured to perform control on the read image temporarily saved in the storage unit. After start of the image reading process, access information for accessing the control unit is displayed on the operation unit.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an example schematic configuration of an image reading apparatus 100;

FIG. 2 is a cross-sectional view illustrating an example schematic configuration of an image reading unit 104;

FIG. 3 is a block diagram illustrating an example hardware configuration of the image reading apparatus 100;

FIG. 4 is a diagram illustrating an example configuration of an image reading system;

FIG. 5 is a block diagram illustrating an example functional configuration of the image reading apparatus 100;

FIG. 6 is a flowchart illustrating a quick scanning process by the image reading apparatus 100 in Embodiment 1;

FIGS. 7A to 7C illustrate user interface (UI) display application screens in Embodiment 1;

FIG. 8 is a flowchart illustrating an image confirmation process by a terminal 200 in Embodiment 1;

FIGS. 9A and 9B illustrate image confirmation page screens in Embodiment 1;

FIGS. 10A and 10B are flowcharts in a case of using a one-time password in Embodiment 2;

FIG. 11 illustrates a UI display application screen in Embodiment 2;

FIG. 12 illustrates a password confirmation page screen in Embodiment 2;

FIG. 13 is a flowchart illustrating a two-dimensional code updating process in Embodiment 3;

FIG. 14 illustrates a UI display application screen in Embodiment 3;

FIG. 15 is a flowchart in a case where a timeout occurs in Embodiment 4; and

FIG. 16 illustrates a UI display application screen in Embodiment 5.

### DESCRIPTION OF THE EMBODIMENTS

### Embodiment 1

First, an example configuration of an image reading apparatus (document conveyance apparatus) according to Embodiment 1 of the present disclosure will be described.

### Image Reading Apparatus

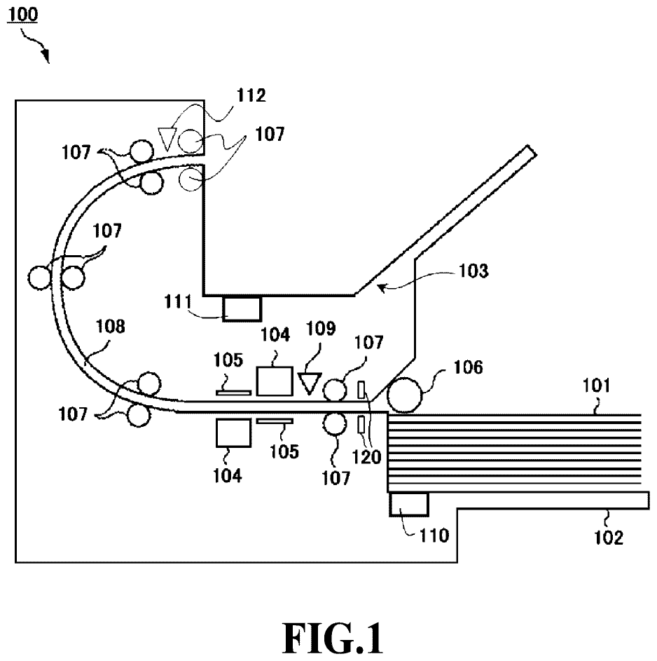

FIG. 1 is a cross-sectional view illustrating an example schematic configuration of an image reading apparatus 100 according to the present embodiment.

The image reading apparatus 100 includes a document table 102 on which documents 101 to be read are placed. The documents on the document table 102 are detected by a document detection sensor 110. The documents on the document table 102 get separated and fed one by one into a conveyance path 108 by a sheet feed roller 106. A document 101 fed into the conveyance path 108 and conveyed through the conveyance path 108 is detected by a registration sensor 109. In response to the registration sensor 109 detecting the document 101, image reading units 104 serving as an image reading unit start reading the images on the document 101 being conveyed through the conveyance path 108 (the images formed on the document).

As illustrated in FIG. 1, the image reading apparatus 100 in the present embodiment includes two image reading units 104 on both sides of the conveyance path 108. One of the image reading units 104 is configured to read the image on a first surface (front surface) of the document 101 while the other image reading unit 104 is configured to read the image on a second surface (back surface) of the document 101. A background plate 105 is disposed at a position on the opposite side of the conveyance path 108 from each image reading unit 104. Each background plate 105 is, for example, a black member. Note that the image reading apparatus 100 may be configured to include only one image reading unit 104.

The document 101 subjected to the image reading by the image reading units 104 is conveyed through the conveyance path 108 toward a discharge component 103 by conveyance rollers 107, and is finally discharged by the discharge component 103 and stacked onto the discharge component 103. A document detection sensor 111 provided to the discharge component 103 is used to detect the document 101 discharged and stacked onto the discharge component 103. Also, a document detection sensor 112 provided around the discharge port of the conveyance path 108 is used to detect the document 101 remaining in the conveyance path 108. By using the document detection sensors 111 and 112, it is possible to detect whether the document 101 is remaining in the conveyance path 108 or has been discharged onto the discharge component 103.

The image reading apparatus 100 further includes a double-feed detection sensor 120 at a position between the sheet feed roller 106 and the registration sensor 109 along the conveyance path 108. The double-feed detection sensor 120 is used to detect double feed in which multiple documents are conveyed one on top of another (a state where the multiple documents stick to one another due to static electricity or the like) through the conveyance path 108. The double-feed detection sensor 120 is, for example, an ultrasonic sensor including an ultrasonic wave transmission component and an ultrasonic wave reception component. In a case of using the ultrasonic sensor, double feed can be detected based on the amount of ultrasonic waves that attenuate when penetrating through the documents (document sheets) in the conveyance path 108.

The document detection sensors 110 to 112 and the double-feed detection sensor 120 are controlled by a later-described control component 10 (CPU 11).

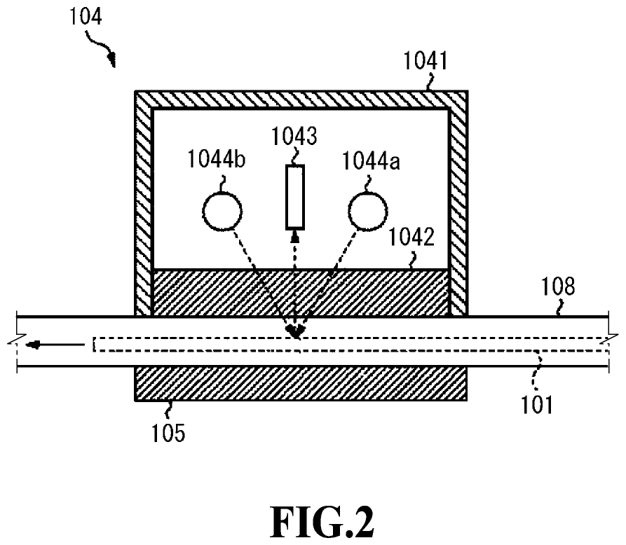

FIG. 2 is a cross-sectional view illustrating an example schematic configuration of an image reading unit 104. The image reading unit 104 includes a housing 1041 and a glass plate 1042 provided to face the conveyance path 108. The housing 1041 and the glass plate 1042 tightly seals the inside of the image reading unit 104. The image reading unit 104 incorporates an image sensor 1043 and a pair of light emitting components 1044a and 1044b.

The image sensor 1043 is a line image sensor and is, for example, a charge coupled device (CCD) line sensor or a contact image sensor. The image sensor 1043 is disposed along a direction orthogonal to the conveyance direction of the document 101 (main scanning direction). The image sensor 1043 reads the image on the document 101 being conveyed on a line-by-line basis in the main scanning direction and outputs an image signal.

The light emitting component 1044a has a light source disposed upstream of the image sensor 1043 in the conveyance direction of the document 101. The light emitting component 1044b has a light source disposed downstream of the image sensor 1043 in the conveyance direction of the document 101. The image sensor 1043 is disposed at a position between the light emitting components 1044a and 1044b. Each of the light emitting components 1044a and 1044b is disposed along the main scanning direction in parallel to the image sensor 1043 and formed of a light emitting diode (LED) array including multiple LEDs. As illustrated in FIG. 2, the image sensor 1043 reads the image on the document 101 by receiving light applied to the document 101 from the light emitting components 1044a and 1044b and reflected on the document 101.

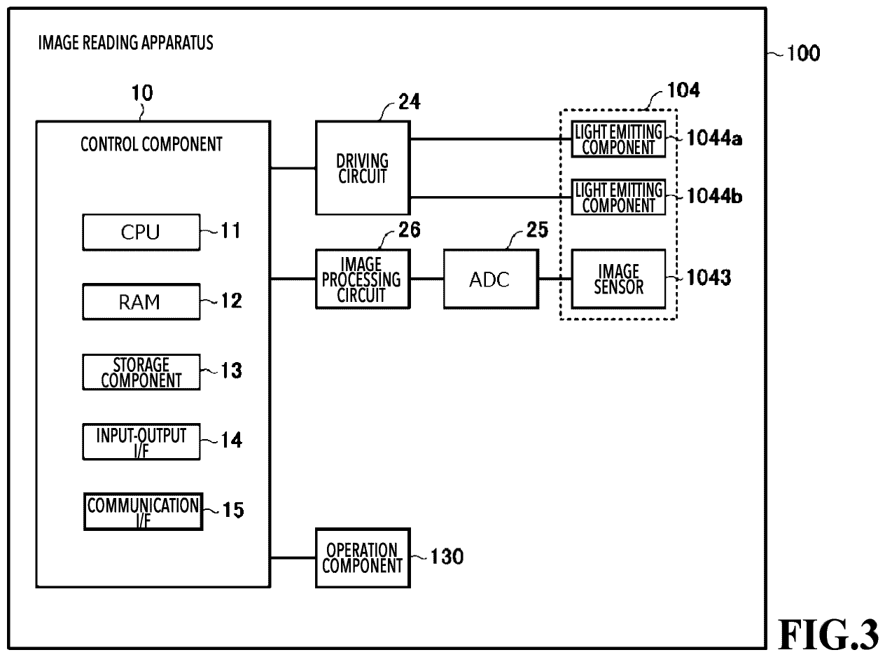

FIG. 3 is a block diagram illustrating an example hardware configuration of the image reading apparatus 100 according to the present embodiment.

The control component 10 of the image reading apparatus 100 includes the CPU 11, a random access memory (RAM) 12, a storage component 13, an input-output interface (I/F) 14, and a communication I/F 15 and serves as a control unit.

The CPU 11 includes one or more processors. The CPU 11 comprehensively controls the image reading apparatus 100 by reading out programs stored in the storage component 13 into the RAM 12 and executing them. The RAM 12 is used as a work area for the CPU 11. Note that the RAM 12 is a volatile memory, so that the data therein is erased in a case where the image reading apparatus 100 is powered off. The storage component 13 is configured to store various programs to be executed by the control component 10 (e.g., control programs) and various pieces of information or data to be used in processing by the control component 10. For example, image data obtained by the document image reading by the image sensor 1043 is saved to the storage component 13. The storage component 13 includes one or more storage devices (memories), such as RAMs, read only memories (ROMs), hard disk drives (HDDs), or solid state drives (SSDs), for example.

A driving circuit 24 and an image processing circuit 26 are connected to the input-output I/F 14. The driving circuit 24 drives the light emitting components 1044a and 1044b of the image reading units 104. The image processing circuit 26 is connected to the image sensor 1043 through an analog-to-digital converter (ADC) 25. The image sensor 1043 reads the image on the document 101 being conveyed on a line-by-line basis in the main scanning direction and outputs an image signal. The ADC 25 converts an analog image signal output from the image sensor 1043 into digital image data and outputs it. The image processing circuit 26 performs image processing, such as shading correction, on the image data output from the ADC 25. The CPU 11 obtains the image data output from the image processing circuit 26.

The communication I/F 15 is an interface for communicating with external apparatuses, and may be a wired communication interface, a wireless communication interface for performing wireless local area network (LAN) communication or Bluetooth (registered trademark) communication, or the like, a universal serial bus (USB) interface, a Small Computer System Interface (SCSI) interface, or the like. In the present embodiment, the communication I/F 15 is exemplarily a wired communication interface connected to a wired LAN. Note that the image reading apparatus 100 may include multiple communication I/Fs 15 to be connected to individual external apparatuses or networks. For example, the image reading apparatus 100 may include a USB or SCSI interface directly connected to an external apparatus and a wired communication interface connected to a wired LAN as the multiple communication I/Fs 15.

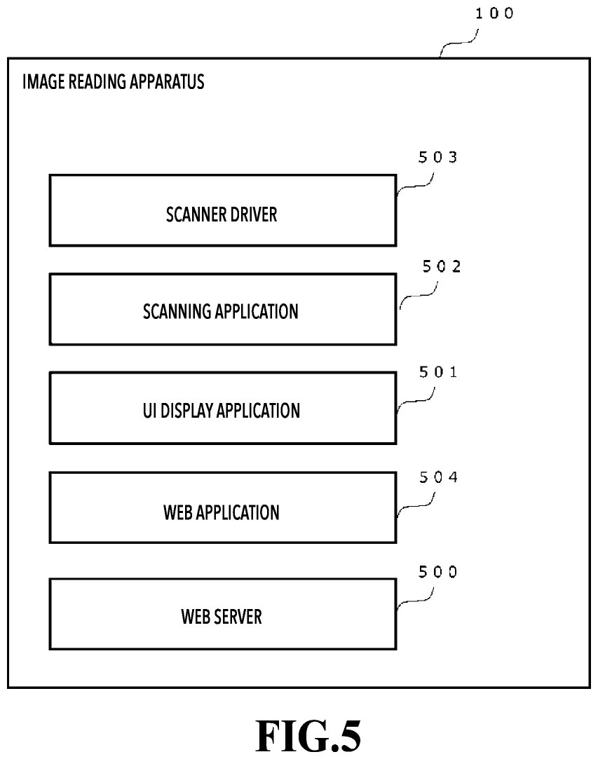

The communication I/F 15 is capable of communicating external apparatuses in compliance with any communication protocol and is capable of communicating with the external apparatus through any communication path. In a case where multiple external apparatuses are connected, a different communication protocol and communication path may be used for each external apparatus. For example, the communication I/F 15 may communicate with one terminal in compliance with a HyperText Transfer Protocol (HTTP) protocol and communicate with another terminal in compliance with a File Transfer Protocol (FTP) protocol. The image reading apparatus 100 in the present embodiment has a web server 500 (see FIG. 5) capable communicating external apparatuses in compliance with an HTTP protocol. Thus, external apparatuses are capable of accessing the web server 500 of the image reading apparatus 100 through web browsers that run on those external apparatuses.

The image reading apparatus 100 includes an operation component 130 connected to the control component 10. The operation component 130 serving as an operation unit includes an input component and output component not illustrated. The input component includes a touch panel, hardware keys, and the like and accepts various operations from the user. The output component (display component) includes a display device, such as a liquid crystal display, and outputs (displays) various pieces of information to the user. The input component and the output component may be implemented in the form of a single module, such as a touch panel display.

### Image Reading Process

In the image reading apparatus 100, the control component 10 (CPU 11) starts an image reading process on a document 101 set on the document table 102 in response to receiving an instruction to start reading the document (scan instruction) via an operation on the operation component 130 or from an external apparatus, for example. In the image reading process, the CPU 11 firstly drives the sheet feed roller 106 to start conveying the document 101 from the document table 102. In a case where multiple documents 101 are set on the document table 102, the documents are separated and conveyed one by one into the conveyance path 108. Then, in response to the registration sensor 109 detecting the document 101, the CPU 11 controls each image reading unit 104 to read the image on the document 101 based on the timing of the detection.

Specifically, the CPU 11 controls the light emission of the light emitting components 1044a and 1044b and drives the image sensor 1043 to read the image on the document 101. The image reading unit 104 reads the image on the document 101 with the image sensor 1043, generate image data of the read image, and outputs the generated image data to the control component 10. The control component 10 temporarily saves the obtained image data to the RAM 12 of the image reading apparatus 100. Note that the image data may be saved to an external apparatus (server apparatus) capable of communicating with the image reading apparatus 100.

### Configuration of Image Reading System

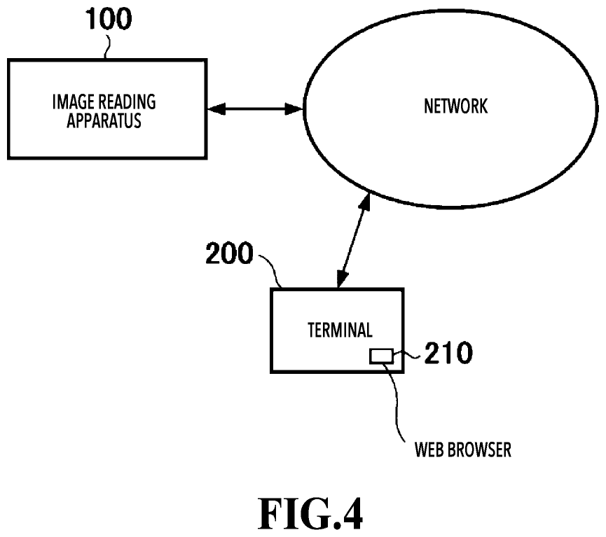

FIG. 4 illustrates an example configuration of an image reading system according to the present embodiment.

The image reading system includes the image reading apparatus 100 and a terminal apparatus (terminal) 200 capable of communicating with the image reading apparatus 100 through a network. The network includes a wired LAN, a wireless LAN, and the like. In the present embodiment, the communication I/F 15 of the image reading apparatus 100 is communicably connected to the terminal 200 through the network.

The terminal 200 is an information processing apparatus such as a personal computer (PC) or a mobile terminal, for example. For example, in a case where the terminal 200 is a mobile terminal, such as a smartphone or a tablet, the terminal may communicate with the image reading apparatus 100 by wirelessly connecting to a wireless access point for wireless LAN communication and connecting to a wireless LAN through the wireless access point.

In the present embodiment, the terminal 200 is a terminal apparatus to be used by a user who operates the image reading apparatus 100 (operating user). A web browser 210 has been installed in the terminal 200 in advance. The operating user operates the image reading apparatus 100 through the web browser 210 running on the terminal 200. The terminal 200 accesses the web server 500 (see FIG. 5) of the image reading apparatus 100 through the web browser 210 in accordance with the operating user's operation.

In this way, the web browser 210 obtains a web application 504 illustrated in FIG. 5 to be described later from the web server 500 as screen data corresponding to an operation screen for operating the image reading apparatus 100, and displays the operation screen on the terminal 200 based on the obtained Hypertext Markup Language (HTML) data. In the present embodiment, the web application 504 is constructed of HTML data, but is not limited to this. The web application 504 may be configured as a Common Gateway Interface (CGI) application.

### Software Functional Configuration of Image Reading Apparatus

FIG. 5 is a block diagram illustrating an example functional configuration (example software configuration) of the image reading apparatus 100.

The image reading apparatus 100 has the web server 500 as a server application that runs on an operation system (OS). During activation of the image reading apparatus 100, the CPU 11 launches the OS and then activates the web server 500.

The web server 500 operates as a resident process on the CPU 11 and further launches the web application 504. Also, the web server 500 stands by until receiving a request through the network and, in response to receiving a request, returns a response or the web application 504 for the request.

Further, the image reading apparatus 100 has a UI display application (UI display app) 501, a scanning application (scanning app) 502, and a scanner driver 503.

The UI display app 501 controls the display of screens on the operation component 130 illustrated in FIG. 3. In response to accepting an instruction to start an image reading process (scan instruction), the scanning app 502 is launched by the UI display app 501. The scanning app 502 controls the image reading units 104 through the scanner driver 503 in accordance with the accepted scan instruction to perform an image reading process (scanning process).

Also, the scanning process can be started in response to a request received by the web server 500 described earlier. In that case, the user access the web server 500 with the web browser 210 on the terminal 200. The web browser 210 obtains the web application 504 from the web server 500 as screen data corresponding to an operation screen for image reading. In response to the user issuing an instruction to start an image reading process through the operation screen on the web application 504, the instruction to start an image reading process is transmitted to the web server 500. After accepting the instruction to start an image reading process, the web server 500 launches the scanning app 502. The scanning app 502 controls the image reading units 104 through the scanner driver 503 in accordance with the accepted scan instruction to perform an image reading process (browser scanning process).

### Quick Scanning Function

A quick scanning function which is a characteristic feature of the present disclosure will be described. The quick scanning function is a function to start a scan without setting the transmission destination, unlike the normal scanning function. In particular, by performing a scanning process based on any scan settings saved in advance in the storage component 13 illustrated in FIG. 3, the image reading can be started immediately after the user places the document. Specifically, with the quick scanning function in this case, the user only needs to place the document on the document table 102 and press a scan start button on the UI display app 501 displayed on the operation component 130 of the image reading apparatus to execute a scanning process and generate image data of the read image.

### Flowchart of Quick Scanning Process

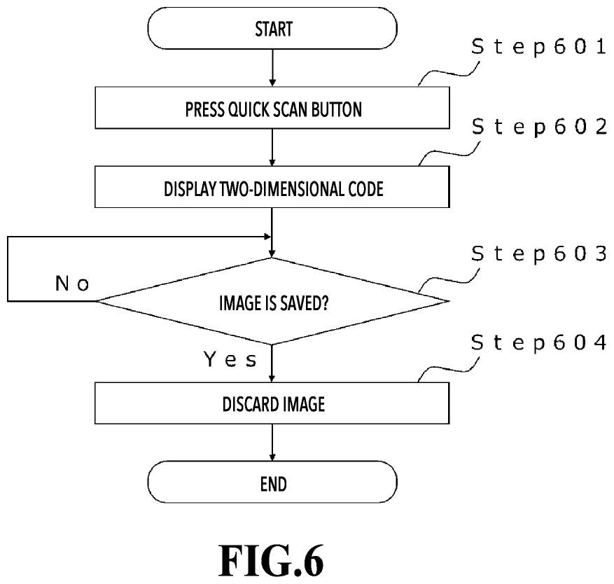

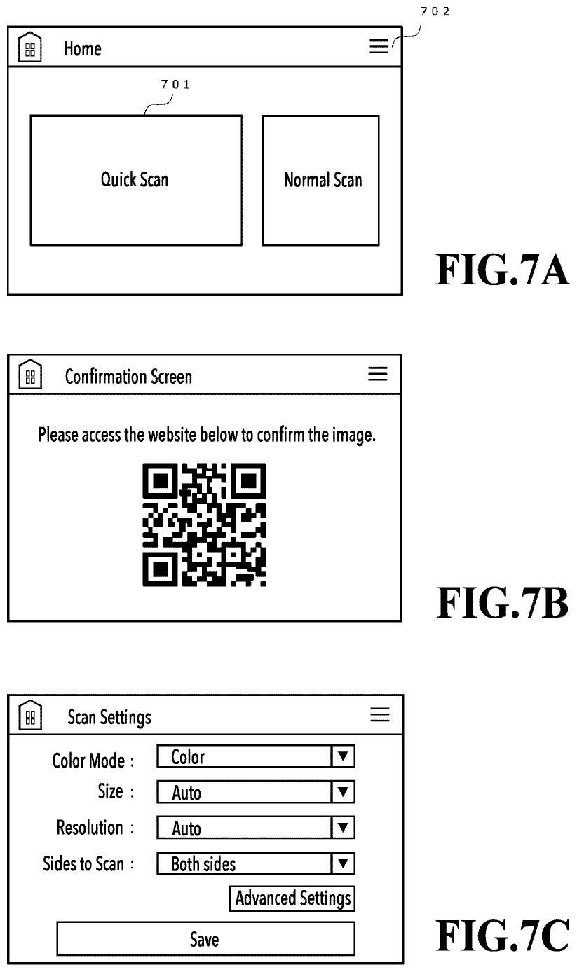

A quick scanning process in Embodiment 1 will now be described using FIG. 6 to FIG. 7C. FIG. 6 is a flowchart illustrating the quick scanning process by the image reading apparatus 100. FIGS. 7A to 7C are diagrams illustrating the UI display app 501 in Embodiment 1.

In Step 601, the user presses a quick scan button 701 on the operation screen illustrated FIG. 7A that is displayed on the UI display app 501, in response to which a scanning process is started based on any scan settings saved in advance in the storage component 13.

As a storage unit, the RAM 12 of the image reading apparatus 100 temporarily saves the scan image (read image) data obtained by the scanning process. Note that the location to temporarily save the scan image data may be the storage component 13 or an external storage area not illustrated that is connected to the image reading apparatus 100.

After the press on the quick scan button 701 (Step 601) (after an instruction to start an image reading process is issued) is Step 602, in which the UI display app 501 creates a two-dimensional code information as access information that serves as a link to a URL for accessing an image confirmation page (web application 504) and displays it as illustrated in FIG. 7B. Note that the two-dimensional code is created using, for example, an open source library for creating two-dimensional codes. The created two-dimensional code is saved to the RAM 12 or the storage component 13.

Also, in the present embodiment, a two-dimensional code is created but the URL as access information to the image confirmation page (web application 504) (e.g., http://192.168.10.3/gazou-kakunin) may be directly displayed on the UI display app 501 to prompt the user to connect to the image confirmation page from the web browser 210 on the terminal 200.

After the two-dimensional code is displayed on the UI display app 501 (Step 602), the web server 500 confirms in Step 603 whether image data is saved. The image data is saved by a user operation on the image confirmation page (web application 504). The image confirmation page (web application 504) will be described later. If image data has not yet been saved (Step 603: No), the web server 500 repeats the process of Step 603.

If image data is saved (Step 603: YES), then in Step 604, the web server 500 deletes the image data temporarily saved in the RAM 12, and the UI display app 501 displays the operation screen in FIG. 7A. The processing then ends.

Note that the scan settings to be used during the execution of a quick scan have been selected on a scan setting screen as illustrated in FIG. 7C provided by the UI display app 501 and saved to the storage component 13 in advance. The scan setting screen may be displayed by a menu button 702, for example. In the present embodiment, each scan setting is saved in the form of a file in a text format in the storage component 13. However, the form of each scan setting is not limited to this. Each scan setting may be saved in the form of binary data. Also, the scan settings to be used during the execution of the quick scan are not limited to those saved in advance to the storage component 13. A scan setting screen similar to the scan setting screen in FIG. 7C or the like may be displayed after the quick scan button 701 is pressed, and the quick scan may be executed according to the settings on that scan setting screen. Even in that case, the time required before starting the scan will be short as compared to a case of starting the scan after setting up the transmission destination using a USB or the network in advance (in particular, after connecting the terminal apparatus 200 through the network).

### Flowchart of Image Confirmation Process

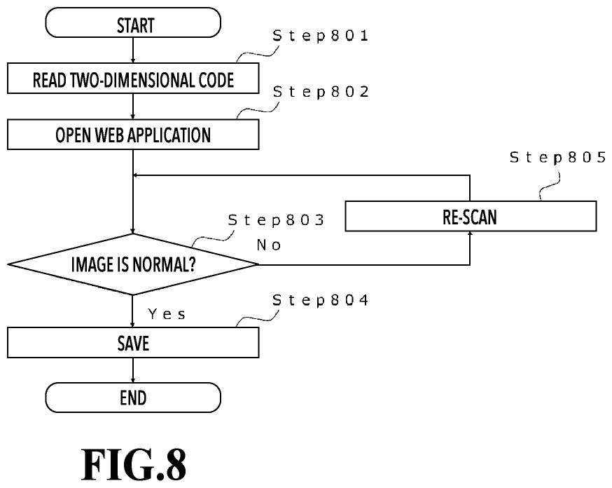

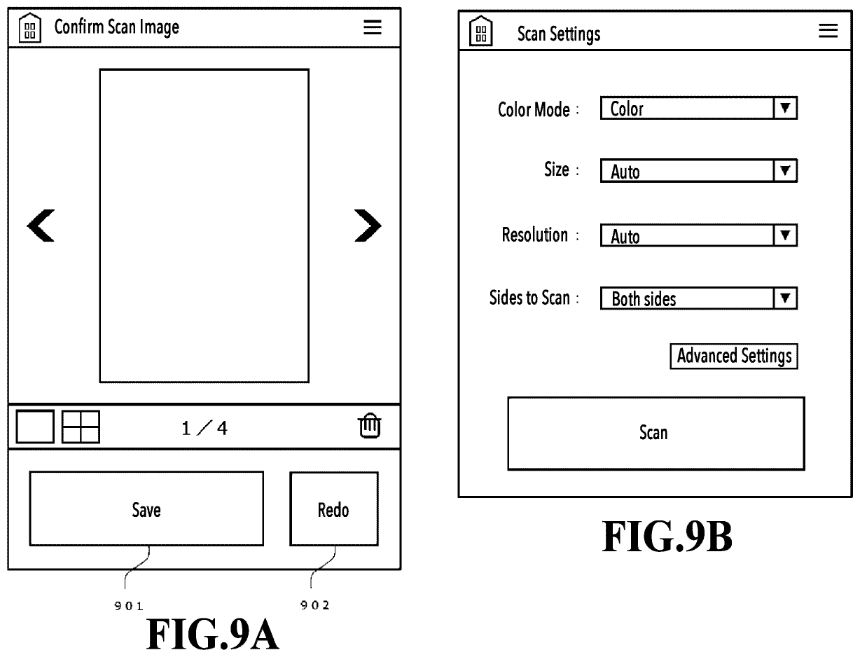

An image confirmation process for a quick scan in Embodiment 1 will now be described using FIG. 8 and FIGS. 9A and 9B. FIG. 8 is a flowchart illustrating an image confirmation process by the terminal 200. FIGS. 9A and 9B are diagrams illustrating the image confirmation page (web application 504) in Embodiment 1.

In a case where the image reading apparatus 100 executes a quick scan, a two-dimensional code for accessing the image confirmation page is displayed on the UI display app 501 as illustrated in FIG. 7B in the process of Step 602 described earlier.

In Step 801, a camera mounted on the terminal 200 (not illustrated) is activated and reads the two-dimensional code. The two-dimensional code is a link to the image confirmation page being the web application 504, which runs on the web server 500. Note that the image confirmation page can be created in HTML and accessed by web browsers. Note that the terminal 200 may access the web server 500 with a general-purpose (default) web browser installed in the terminal 200 or by web access from an application installed in the terminal 200. Both cases are similar. Thus, in the following description, a case where the web browser 500 is accessed with the general-purpose web browser will be described as an example.

In Step 802, after the two-dimensional code is read (Step 801), the web browser 210 on the terminal 200 is launched and opens an image confirmation page as illustrated in FIG. 9A. The image confirmation page is created in HTML so that image data saved in the RAM 12 can be referred to. For example, image data may be displayed on the web browser 210 using an HTML image tag. However, the image confirmation page is not limited to this. The image confirmation page may be created to display a page subjected to Base64 conversion or data encrypted in consideration of security. In this case, if the image confirmation page is accessed during the scan, an HTML page in a state where an image page whose scanning has been completed up to that point is returned. After that, the web browser 210 issues an image request access to the web application 504 at predetermined time intervals until the scanning of the document placed on the document table 102 is completed. While receiving this image request access at the predetermined time intervals, the web application 504 returns, to the web browser 210, an image confirmation page updated to a state where the image whose scanning has been completed at that point can be referred to. On the other hand, in a case of stopping receiving access at the predetermined time intervals, the scanning may be stopped. In this case, the UI display app 501 of the image reading apparatus 100 or the like may be notified that the connection has been lost. The configuration may be such that the scanning can be resumed once the access with the same session ID as that before the stoppage resumes.

After the web application 504 (image confirmation page) is opened on the terminal 200 (Step 802), the user confirms in Step 803 whether the image data has any problems, such as defects. If the image data has no problem (Step 803: YES), then in Step 804, the user presses a save button 901 for saving the image data to save the image to the terminal 200, and the processing ends. A downloading function provided to the web browser 210 may be used to save the image. For example, a download attribute may be added to the save button's tag. Also, a sharing function provided to the terminal 200 may be used to set an external storage or a different terminal as the saving destination. The configuration may be such that, in a case of transmitting the image to an external storage, credential information required to access the external transmission destination may be accessed by causing the web server 500 to obtain information held in the terminal 200 or by accessing the external transmission destination via the terminal 200.

If the image data has a defect (Step 803: NO), then in Step 805, the user presses a redo button 902 illustrated in FIG. 9A to perform an image reading (browser scanning) process again (re-scan) with the web browser 210, and the process of Step 803 is repeated. Note that, in the case of performing a re-scan in Step 805, the user may set new scan settings on a scan setting page as illustrated in FIG. 9B, which is provided by the web application 504. Note that an example in which the redo button 902 is provided in a case where the image data has a defect has been presented, but what is provided is not limited to this. For example, a button for performing an additional scan may be provided, and a button with which an image can be added in addition to the scanned image may be provided. It is preferable to maintain the connection between the web browser 210 and the web server 500 even in a case where the redo button or the additional scan button is pressed. In particular, while the configuration may be such that, in a case where the redo button 902 is pressed, the web browser 210 and the web server 500 may be disconnected and then re-connected again, maintaining the connection makes it possible to prioritize the redoing of the scanning even in a case where another connection request is given. This improves usability, and also prevents a situation where the scan image is transmitted to a different person and thus improves security.

As described above, the user can omit launching of the scanning app, selection of scan settings, and the like and start a scan immediately after placing a document and save the image data to the user's terminal.

### Embodiment 2

In Embodiment 2, a quick scan in a case of using a one-time password as permission information for permitting access in consideration of security will be described. Note that the image reading apparatus 100, the image reading process, the configuration of the image reading system, the software functional configuration of the image reading apparatus, the quick scanning function, and the image confirmation process are similar to those in Embodiment 1, and description thereof will therefore be omitted.

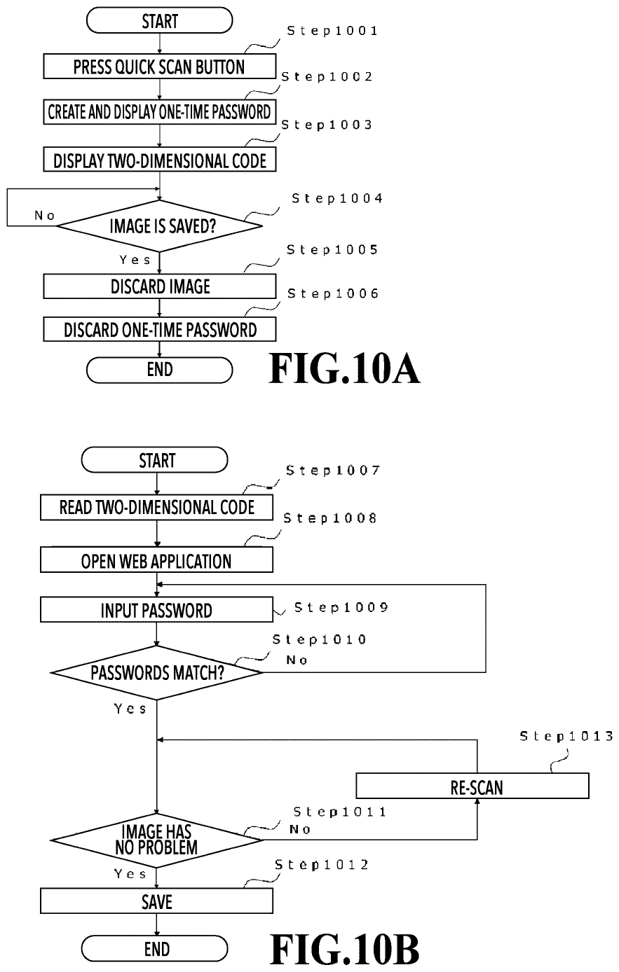

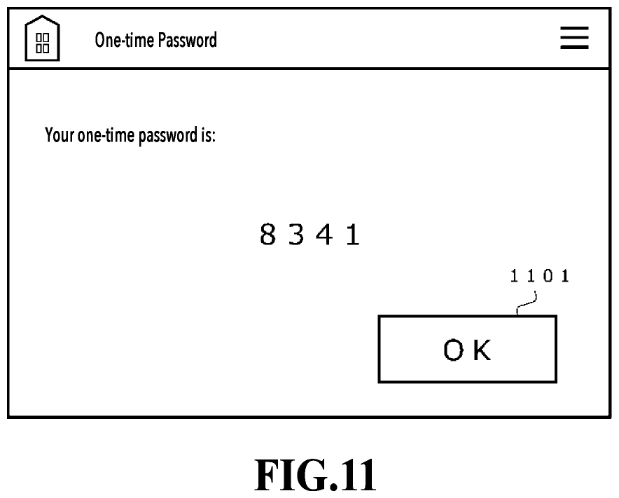

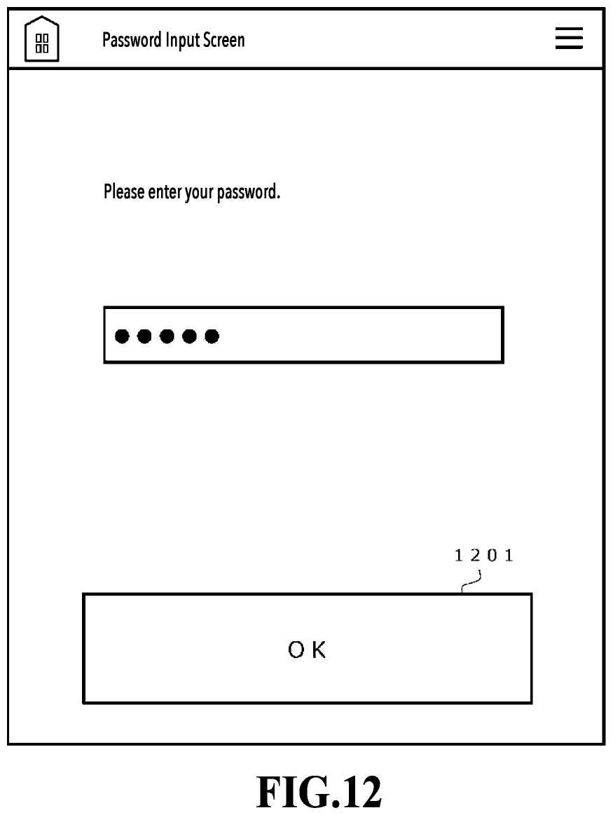

FIG. 10A is a flowchart illustrating processing by the image reading apparatus 100 in the case of using a one-time password. Also, FIG. 10B is a flowchart illustrating an image confirmation process by the terminal 200 in the case of using a one-time password. FIG. 11 is a diagram illustrating the UI display app 501 in Embodiment 2. FIG. 12 is a diagram illustrating an image confirmation page (web application 504) in Embodiment 2.

### One-time Password Issuing Screen

In Step 1001, the user presses the quick scan button 701 on the operation screen illustrated FIG. 7A that is displayed on the UI display app 501, in response to which a scan is started based on any scan settings saved in advance in the storage component 13 illustrated in FIG. 3. The scan image data obtained by the scan is temporarily saved to the RAM 12 of the image reading apparatus 100. Note that the location to temporarily save the image data may be the storage component 13 or an external storage area not illustrated that is connected to the image reading apparatus 100.

In Step 1002, the web server 500 creates a one-time password and saves it to the RAM 12. Further, as illustrated in FIG. 11, the web server 500 displays the one-time password on the UI display app 501. In a case where user presses an OK button 1101, the one-time password screen is closed.

Note that, in Embodiment 2, the one-time password is an arbitrarily issued four-digit numerical value but is not limited to this. A unique user ID (UID) may be used.

After a one-time password is created and displayed (Step 1002), in Step 1003, the web server 500 creates two-dimensional code information for accessing the image confirmation page (web application 504) and displays it on the UI display app 501, as illustrated in FIG. 7B.

After the two-dimensional code information is created and displayed (Step 1003), the web server 500 confirms in Step 1004 whether image data is saved. The image data is saved by a user operation on the image confirmation page (web application 504). The access to the image confirmation page (web application 504) and the image confirmation process will be described later.

If image data has not yet been saved (Step 1004: No), the web server 500 repeats the process of Step 1004. If image data is saved (Step 1004: YES), then in Step 1005, the web server 500 deletes the image data temporarily saved in the RAM 12.

After discarding the image data (Step 1005), the web server 500 discards the one-time password in Step 1006, and the processing ends.

### One-time Password Confirmation Screen

The camera mounted on the terminal 200 (not illustrated) is activated and reads the two-dimensional code for accessing the image confirmation page displayed (Step 1003) on the UI display app 501 as illustrated in FIG. 7B mentioned above (Step 1007). The two-dimensional code is a link to the image confirmation page (the web application 504) which runs on the web server 500. Note that the image confirmation page (web application 504) can be created in HTML and accessed by web browsers.

After the two-dimensional code is read (Step 1007), in Step 1008, the web browser 210 in the terminal 200 is launched and opens the image confirmation page (web application 504).

After the web application 504 is opened (Step 1008), in Step 1009, a password input page is displayed on the image confirmation page (web application 504) as illustrated in FIG. 12, and the user inputs a password into the password input page.

After the password is input (Step 1009) and an OK button 1201 illustrated in FIG. 12 is pressed, the web application 504 confirms in Step 1010 whether the one-time password saved in the RAM 12 and the input password match.

If the passwords do not match (Step 1010: NO), the process of Step 1009 is repeated. At that time, a message as a notification indicating that the passwords do not match may be displayed on the web application 504.

If the passwords match (Step: YES), the image confirmation screen illustrated in FIG. 9A is displayed and the user confirms in Step 1011 whether the image data has any problems, such as defects.

If the image data has no problem (Step 1011: YES), then in Step 1012, the user presses the save button 901 for saving the image data illustrated in FIG. 9A to save the image to the terminal 200, and the processing ends.

If the image data has a defect (Step 1011: NO), then in Step 1013, the user presses the redo button 902 illustrated in FIG. 9A to perform a re-scan, and the process of Step 1011 is repeated.

As described above, by issuing a one-time password, a quick scan with improved security can be performed.

### Embodiment 3

In Embodiment 3, a process of updating a two-dimensional code display screen taking security into account will be described. Note that the image reading apparatus 100, the image reading process, the configuration of the image reading system, the software functional configuration of the image reading apparatus, the quick scanning function, and the image confirmation process are similar to those in Embodiment 1, and description thereof will therefore be omitted.

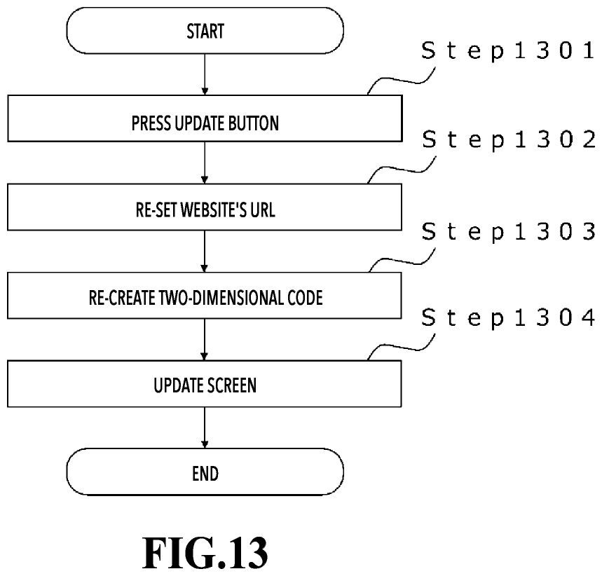

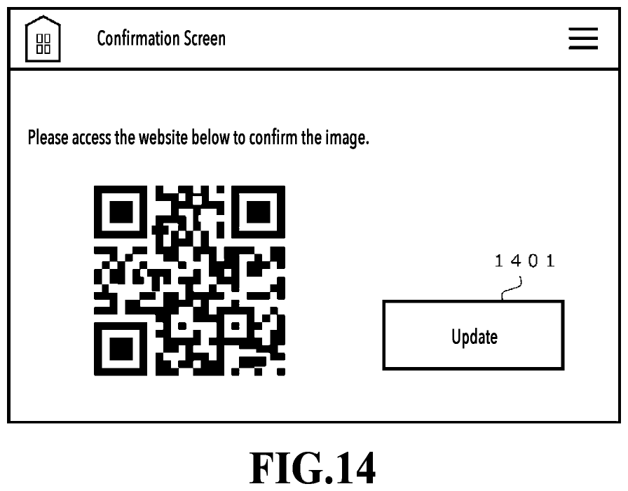

FIG. 13 is a flowchart illustrating a two-dimensional code updating process in Embodiment 3. Also, FIG. 14 illustrates a UI display application screen in Embodiment 3.

After a quick scanning process, a two-dimensional code is displayed on the UI display app 501, as illustrated in FIG. 14. In Step 1301, the user presses a two-dimensional code update button 1401 displayed on the UI display app 501.

In response to the press on the two-dimensional code update button 1401 (Step 1301), in Step 1302, the web server 500 re-sets the URL of the image confirmation page (web application 504). In the present embodiment, the date and time are incorporated into the URL to create a unique URL (e.g., http://192.168.10.3/gazou-kakunin/2024-09-03-16-56-45). However, the URL is not limited to this. A unique URL may be created by generating a random number.

After the URL is re-set (Step 1302), in Step 1303, the web server 500 creates a new two-dimensional code as a link to the URL of the web application 504.

After re-creating a two-dimensional code (Step 1303), in Step 1304, the web server 500 displays the re-created two-dimensional code on the UI display app 501 (screen update), and the processing ends.

Updating the two-dimensional code as described above prevents access to the image confirmation page by a third party in case where the two-dimensional code is unexpectedly browsed by the third party. Note that, in the present embodiment, a two-dimensional code is displayed, but URL information may be directly displayed, and the form of display is not limited to the above. Also, in response to access to the displayed two-dimensional code, the screen of the UI display app 501 may be switched a display indicating that fact, and the two-dimensional code may be hidden. At that time, it is preferable to simultaneously display information with which the terminal 200 accessing the two-dimensional code can be specified. Such a configuration can prevent access to the image confirmation page by third parties in a more suitable manner and also easily specify the terminal on which the image confirmation page is currently displayed.

### Embodiment 4

In Embodiment 4, a timeout process for image confirmation will be described. Note that the image reading apparatus 100, the image reading process, the configuration of the image reading system, the software functional configuration of the image reading apparatus, the quick scanning function, and the image confirmation process are similar to those in Embodiment 1, and description thereof will therefore be omitted.

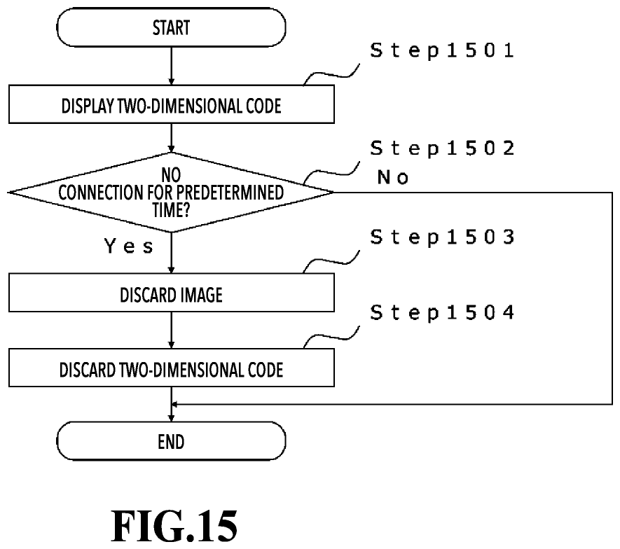

FIG. 15 is a flowchart illustrating processing in a case where a timeout occurs.

After a quick scanning process, in Step 1501, a two-dimensional code is displayed on the UI display app 501.

After the two-dimensional code is displayed on the UI display app 501 (Step 1501), in Step 1502, it is confirmed for a predetermined time after displaying the two-dimensional code whether the image confirmation page (web application 504) is accessed. If the image confirmation page is not accessed within the predetermined time (Step 1502: YES), then in Step 1503, the web server 500 discards the image data saved in the RAM 12. If the image confirmation page is accessed (Step 1502: NO), the processing ends.

Whether the image confirmation page is accessed is determined based on whether there is an HTTP request for the web application 504 from an external terminal. For example, the determination may be made based on a GET method issued by the web browser 210.

After the image data is discarded (Step 1503), in Step 1504, the two-dimensional code saved in the RAM 12 is discarded, and the processing ends.

As described above, in a case where there is no operation for a predetermined time, the image data is discarded and the image reading apparatus is made available. This prevents the image reading apparatus from remaining unavailable.

### Embodiment 5

In Embodiment 5, a process of indicating that another user is using the image reading apparatus on the image reading apparatus after a quick scan will be described. Note that the image reading apparatus 100, the image reading process, the configuration of the image reading system, the software functional configuration of the image reading apparatus, the quick scanning function, and the image confirmation process are similar to those in Embodiment 1, and description thereof will therefore be omitted.

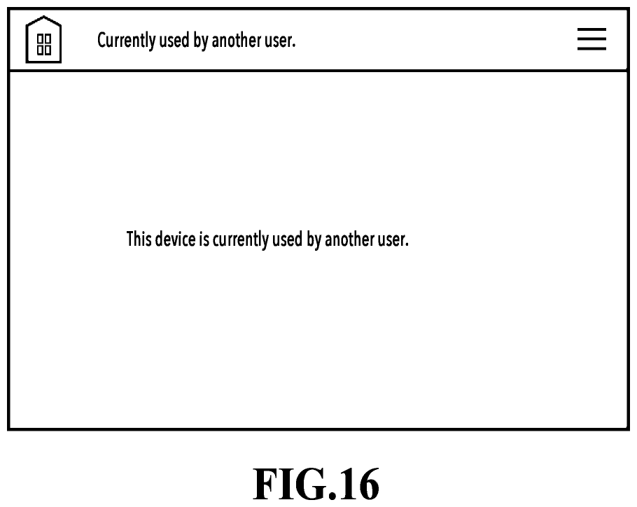

FIG. 16 illustrates a UI application screen in Embodiment 5.

After a quick scanning process, the user reads a two-dimensional code displayed on the UI display app 501 with the camera mounted on the terminal 200 (not illustrated) and accesses the image confirmation page (web application 504). In response to this, a message “This device is currently used by another user.” as illustrated in FIG. 16 is displayed on the UI display app 501.

In a case where the user saves the image through the image confirmation page (web application 504), the display on the UI display app 501 ends.

As described above, while a user is confirming an image on the image confirmation page (web application 504) after a quick scan, a third party can be notified that the image reading apparatus is being used. Displaying the notification that the image reading apparatus is being used may be a normal specification, or preset to be performed, and whether to display or hide the notification may be switched based on the user's selection.

Also, while a user is confirming image data on the terminal 200, a message as a notification indicating that the image reading apparatus 100 is about to be used by another user may be displayed on the terminal 200. In that case, the image data temporarily saved in the RAM 12 may be kept saved instead of being deleted.

According to the present disclosure, it is possible to shorten the time required for a user before scanning a document and obtaining image data.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210994, filed Dec. 4, 2024, and No. 2025-179855, filed Oct. 24, 2025, which are hereby incorporated by reference herein in their entirety.

What is claimed is

1. An image reading apparatus comprising:
an operation unit configured such that a user performs an operation thereon;
an image reading unit configured to perform an image reading process of reading a document;
a storage unit configured to temporarily save an image data obtained by the image reading unit; and
a control unit configured to perform control on the read image temporarily saved in the storage unit, wherein
after start of the image reading process, access information for accessing the control unit is displayed on the operation unit.

2. The image reading apparatus according to claim 1, wherein a user is allowed to read the access information with an information processing apparatus and then confirm and save the read image on the information processing apparatus and issue an instruction to start the image reading process again.

3. The image reading apparatus according to claim 2, wherein in a case of issuing an instruction to start the image reading process from the information processing apparatus, a user is allowed to configure a setting of the image reading process.

4. The image reading apparatus according to claim 1, wherein the control unit displays the access information on the operation unit immediately after a user issues an instruction to start the image reading process with the operation unit.

5. The image reading apparatus according to claim 1, wherein the control unit updates the access information.

6. The image reading apparatus according to claim 1, wherein the control unit discards the access information and the read image temporarily saved in the storage unit in a case where the access information is not accessed for a predetermined time after the access information is displayed on the operation unit.

7. The image reading apparatus according to claim 2, wherein the control unit creates permission information which permits access from the information processing apparatus and, in a case where the read image is saved, discards the permission information and the read image temporarily saved in the storage unit.

8. The image reading apparatus according to claim 2, wherein in a case where a user is confirming the read image with the information processing apparatus, the control unit indicates on the operation unit that the image reading apparatus is being used by the user.

9. An image reading apparatus comprising:
an operation unit configured such that a user performs an operation thereon;
an image reading unit configured to perform an image reading process of reading a document; and
a control unit configured to perform control on an image data obtained by the image reading unit and temporarily saved in an external storage area, wherein
after start of the image reading process, access information for accessing the external storage area is displayed on the operation unit.
